(19) United States
(12) Patent Application Publication
(10) Pub. No.: US 2003/0019539 A1
(43) Pub. Date: Jan. 30, 2003

(54) Container with expandable bladder seal

(76) Inventor: Rick L. Hornwood, Woodland Hills, CA (US)

Correspondence Address: ALBERT O COTA, 5460 WHITE OAK AVE, SUITE A-331, ENCINO, CA, 91316, US

(21) Appl. No.: 09/902,675

(22) Filed: Jul. 12, 2001

(51) Int. Cl. B67C 3/00

(52) U.S. Cl. 141/114; 141/63; 141/313

(57) ABSTRACT

A container for product storage including an expandable portion is provided to eliminate space between the container and the product to prolong the remaining products usable life within the container after opening. The invention includes a storage container (30) that has a cover (32) and product (34) within its interior. An inflatable bladder (36) is disposed within the storage container and a tube (38) penetrates through the container and is connected to the bladder. A valve (48) is attached to the tube's distal end and a pressure source, which could include heat or cooling, is connectable to the valve. The combination of the valve and the pressure source supplies the required pressure to inflate the bladder (36) which occupies the space between the product within the storage container (30) and the cover (32) thereby precluding ambient atmospheric contact with the product. A releasable pressure valve (66) is provided to discharge pressure created within the container when the bladder is inflated.

### TECHNICAL FIELD

The invention pertains to containers in general and more specifically to a container having therein an fluid expandable bladder. The bladder is dimensioned to displace air above or below the contents of the container to maintain product freshness.

### BACKGROUND ART

Previously, other types of inflatable seals have been used in endeavoring to provide an effective means to seal the interior of a circular opening. The most beneficial aspect of using an inflatable bladder or similar device is, that, regardless of the size of the container, a bladder can be constructed to function effectively. As the contents of the container diminishes the bladder can be inflated to compensate for the increased interior space. Of course, a bladder designed for a 12 oz. container will not function with a 5 gallon container however, as long as the bladder is constructed of a strong, resilient material that is capable of maintaining integrity under increased pressure the range of container size can vary greatly. Also, since the bladder is constructed of a resilient material, there exists the ability to securely seal containers with various shapes, which conventionally utilize a simple cap or lid that permits a substantial amount of air, along with whatever product, to be sealed within the container.

A search of the prior art did not disclose any patents that possess the novelty of the instant invention, however the following U. S. patents are considered related:

| U.S. PAT. NO. | INVENTOR | ISSUE DATE |
|---|---|---|
| 3,981,415 | Fowler et al. | Sep. 21, 1976 |
| 4,209,352 | Diaz et al. | Jun. 24, 1980 |
| 4,344,458 | Zahid | Aug. 17, 1982 |
| 4,569,082 | Ainsworth et al. | Feb. 4, 1986 |
| 4,790,544 | Kemp | Dec. 13, 1988 |
| 5,016,856 | Tartaglino | May 21, 1991 |
| 5,096,529 | Baker | Mar. 17, 1992 |
| 5,104,016 | Runkel | Apr. 14, 1992 |
| 5,544,466 | Bonnet | Aug. 13, 1996 |
| 5,560,618 | Wambeke et al. | Oct. 1, 1996 |
| 5,558,245 | White | Sep. 24, 1996 |
| 5,562,295 | Wambeke et al. | Oct. 8, 1996 |
| 5,792,991 | Nolf | Aug. 11, 1998 |
| 5,901,962 | Wambeke | May 11, 1999 |
| 5,979,909 | Wambeke | Nov. 9, 1999 |

U.S. Pat. No. 3,981,415 discloses a container with a volume-expansible bag for dispensing fluid by the contracting force of an expandable fabric bag within the container.

U.S. Pat. No. 4,209,352 discloses an inflatable bag having sealing material thereon and when inflated seals the closure member inside.

U.S. Pat. No. 4,344,458 discloses an accumulator device that has a bladder inside forming a leakproof seal on a integral stem.

U.S. Pat. No. 4,569,082 discloses a bag with a removable inflatable bladder for cushioning articles adjacent to the bladder.

U.S. Pat. No. 4,790,544 discloses a seal in an aperture with an envelope configured to seal various sizes of openings.

U.S. Pat. No. 5,016,856 discloses an angular shaped, inflatable bladder for volume control within air conditioning system ductwork.

U.S. Pat. No. 5,096,529 discloses an adjustable seal assembly bladder with two chambers that are formed by applying heat to the elected edges of the bladder's inner walls.

U.S. Pat. No. 5,544,466 discloses a method of loading and closing containers such as bags using an inflatable bladder.

U.S. Pat. No. 5,560,618 discloses a method of sealing a duct by positioning a device that blocks the interior with an inflatable seal.

U.S. Pat. No. 5,558,245 discloses a bladder seal for a storage tank. The seal prevents overflow between the tank and the bladder with a valve releasing gas and padding on the tank wall minimizes condensation therebetween.

U.S. Pat. No. 5,562,295 discloses a hollow sealing member that is inflated through a hole in a wall to prove sealing.

U.S. Pat. No. 5,792,991 discloses a split housing that is configured to surround an object with the housing having an inflatable bladder on each portion.

U.S. Pat. No., 5,901,962 discloses a flexible sealing member that is inflated to seal a gap between articles.

U.S. Pat. No. 5,979,90 discloses a similar device to his patent above as a continuation of the same application.

### DISCLOSURE OF THE INVENTION

In order to assure freshness and to achieve long shelf life, products stored in containers such as metal cans, plastic and glass bottles are sealed at the time of their introduction, as any air in contact with the product, such as food, promotes the growth of bacteria and fungus. Other products such as contained in paint cans, pill boxes, liquids in 55 gallon drums, gasoline in large storage tanks, plutonium in sealed caverns, left-overs and medicine are also benefited by the invention. For decades, seals in the form of lids have been used to preclude the phenomena of product degeneration and even evacuation of the air at the time of packing has been in common usage. The problem that has prevailed is that once the lid is removed, ambient air is introduced into the interior of the container and the process of decomposition or spoiling, as well as deterioration, of the product begins. Food stuffs are normally stored under refrigeration to prevent or at least attenuate this situation, however many products that do not require refrigeration become in time stale and degrade in taste. Further medicines stored in containers are subject to contaminants entering the interior and product such as paint develops a crust or skin on the top with other products having similar problems due to the entry of oxygen in the air. Therefore the primary object of the invention is to modify a container to include a hole through one of the walls or top and place a inflatable bladder inside the container with a tube penetrating the hole and a valve on the distal end. A person using the invention simply returns the lid or cover on the container and inflates the bladder, which displaces the space between the product and the remainder of the container thus eliminating the dead air space and achieving the desired result or maintain product freshness.

An important object of the invention is that the invention may be used on a multitude of products such as food stuffs, liquids including paint in all its varieties, as well as chemicals that deteriorate or evaporate in the presence of air.

Another object of the invention is that it may be incorporated at the time of product introduction or as an after-market component that is installed by a user after the initial opening of the container. The only modification of the container is to form a hole in a convenient location on the container which is normally the lid or cover. A simple tool, in the form of a punch, may be furnished in a kit and the assembly consists of installing the bladder inside the container with the tube penetrating the hole and the valve placed on the end of the stem as a cap or the stem may be self sealing.

Still another object of the invention is that the bladder seals the hole when it is expanded, thereby eliminating any further requirement, or the hole may be sealed with pressure sensitive adhesive which fills the void the first time or any time it is expanded it is expanded.

Yet another object of the invention is that it may be used in the same container as many times as needed, as the bladder may be deflated with the valve and re-inflated each time the lid is removed or product released or poured.

A further object of the invention is that almost any type of pump may be used to inflate the bladder (even a persons mouth blowing on the tube), also compressed gas may be used in its simple form such as a pressurized can or a carbon dioxide cartridge.

A final object of the invention is the simplicity of the invention as it is intuitively obvious in its function and operation. While being simple to operate, it may also be used with a minimum of equipment, such as omitting the manually-releasable pressure valve and simply cracking the lid in the case of a plastic snap-on cap or unscrewing the lid on a threaded container to release pressure built up within the container when the bladder is inflated.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a partial isometric view of the preferred embodiment for a container which incorporates an internal, expandable bladder seal.

FIG. 2 is a cross sectional view taken along lines 2-2 of FIG. 1 with the product three fourth full.

FIG. 3 is a cross sectional view taken along lines 3-3 of FIG. 1 with the product one fourth full.

FIG. 4 is a partial isometric view of the inflatable bladder connected with the tube on the side, completely removed from the invention for clarity.

FIG. 5 is a partial isometric view of the inflatable bladder connected with the tube on the top, completely removed from the invention for clarity.

FIG. 6 is a partial isometric view of the container with the bladder on the interior bottom and the tube on the side attached to a bulkhead connector.

FIG. 7 is a partial isometric view of a round bladder with the tube connected on the side showing the expansion upward in dotted lines as if it were in the container of FIG. 6.

FIG. 8 is a partial isometric view of the storage container with the bladder on the interior bottom and the tube on the inside attached to a bulkhead connector near the top.

FIG. 9 is a cross sectional view taken along lines 9-9 of FIG. 6 showing a barbed bulkhead connector.

FIG. 10 is a cross sectional view of a valve having a spring-loaded ball and a manual release.

FIG. 11 is a partial isometric view of the manually releasable pressure valve.

FIG. 12 is a partial isometric cut away view of the storage container showing a threaded container cover and the manually releasable pressure valve on the top.

FIG. 13 is a cross sectional view taken along lines 13-13 of FIG. 12.

FIG. 14 is a cross sectional view taken on the centerline of the container with the bladder having an integral neck penetrating through the hole in the cover with the valve connected to the neck prior to inflation.

FIG. 15 is an exploded plan view of the bladder with an integral neck on the side and the valve.

FIG. 16 is a plan view of the bladder with an integral neck on the top.

FIG. 17 is a side view of the bladder with an integral neck on the top.

FIG. 18 is an outline view of a person inflating the bladder orally.

FIG. 19 is a partial isometric view of a hand pump.

FIG. 20 is a partial isometric view of a foot bellows pump.

FIG. 21 is a partial isometric view of a squeeze bulb.

FIG. 22 is a partial isometric view of a electric pump.

FIG. 23 is a partial isometric view of a compressed air can.

FIG. 24 is a partial isometric view of a carbon dioxide cartridge.

FIG. 25 is a side elevational view of the storage container with the bladder on the interior bottom and the tube on the inside attached to an adapter joined to a vertical bore with the tube connected to an additional adapter on the top outside surface of the container.

### BEST MODE FOR CARRYING OUT THE INVENTION

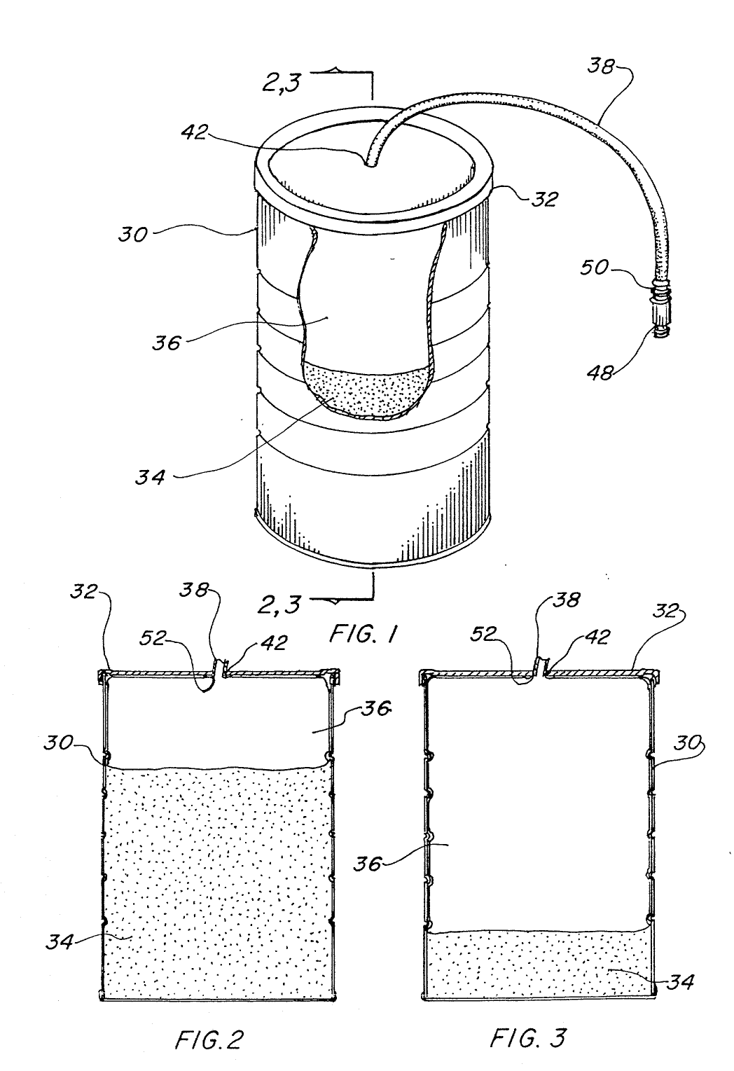

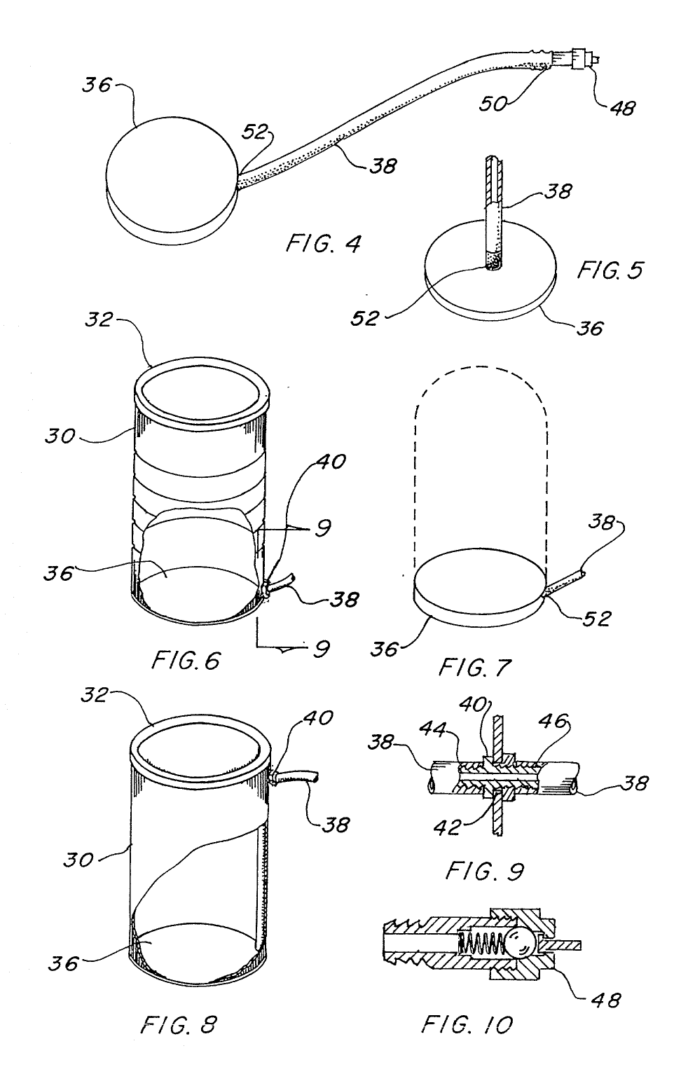

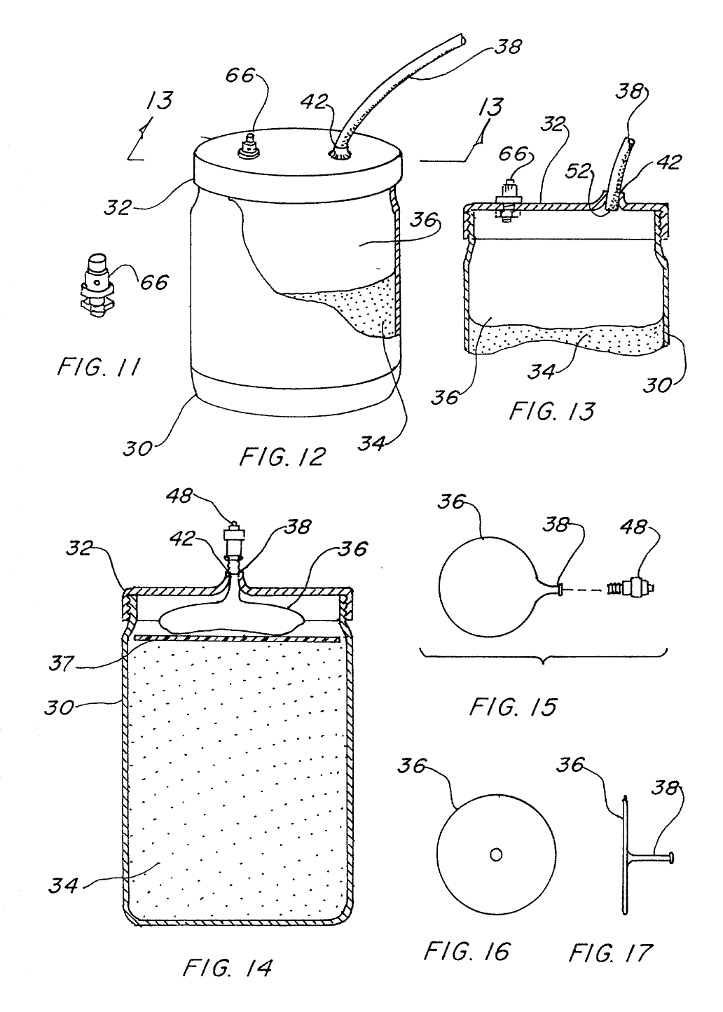

The best mode for carrying out the invention is presented in terms of a preferred embodiment. This preferred embodiment as shown in FIGS. 1 through 25, is comprised of a container for product storage including an expandable portion that functions to eliminate atmospheric air from contacting the product to prolong its usable life.

A storage container 30, having a cover 32 (or lid) along with a product 34 included within the containers interior, are the basic elements of the invention. The container 30 may be any type, such as a metal can with a plastic lid like a coffee can; a plastic jar with a plastic screw on lid, like a food container; a cardboard cylinder with a plastic snap-on lid or a ceramic urn or pot with a stopper. Actually, any type of container that is capable of holding a product inside may include the addition of the invention.

The cover 32 may also be any type and style such as shown in FIGS. 1-3, 6, 8, and 12-14, as there are many varieties available that screw on or snap in place over a bead due to the resilience of the parent material to provide an air tight seal.

The product 34 may be any variety of food stuffs, liquids or substances that benefit by isolation from exposure to ambient conditions. The drawings illustrate this alternative elements as spaced dots inside the container.

An inflatable bladder 36 is disposed within the storage container 30 as illustrated and functions much like blowing up a balloon, which displaces the area above the product 34 within the container thus preventing exposure of the product 34 to the air. The inflatable bladder 36 may be constructed of a resilient material such as natural rubber, synthetic rubber, stretchable fabric impregnated with elastic sealer or resilient thermoplastic. The shape of the bladder 36 may be round, square, rectangular or any other configuration to mate with the internal dimensions of the container 30. While a consistent same thickness of material is normally preferred, the bladder 36 may be thicker on the top or bottom to permit expansion in a particular direction, such as illustrated in FIG. 1-3, where the bladder is positioned on the top and expands only downward into the container 30. Where the product 34 is granulated or in powder form, the bladder 36 may be positioned underneath, such as illustrated in FIGS. 6-8, to actually lift the product upward to fill the void until the bladder engages the cover 32. If pressure is applied to the bladder 36, the product 34 could be released at a faster rate. It is understood that any configuration of the container 30 and bladder 36 incorporating these relationships is anticipated by the inventor.

An optional replaceable separator 37 may be added in between the bladder 36 and the product 34, as illustrated in FIG. 14, to increase the cleanliness of the product and to preclude the product from sticking to the bladder. This separator 37 may be of any thin material such as paper, thermoplastic film, cardboard, aluminum foil or any other substance that is economical and may be easily replaced. The configuration of the separator 37 follows the contour of the inside of the container 30 and may be reused after some of the product has been removed or replaced as a requirement of the particular type of product used in conjunction with the invention particularly if the product sticks to the bottom side of the separator 37 when originally removed.

In order to inflate the bladder 36, a tube 38 is provided that is either integrally formed with the bladder 36 or is attached directly to its major surface. The tube 38 may be of the same material as the bladder or, if it is attached, may be dissimilar as long as it is compatible for attachment purposes such as fusing, welding or adhesive connection. The tube 38 penetrates through the container 30 and is connected to the inflatable bladder 36 inside the container 30. While it is obvious that the penetration is through an outside surface of the container 30 this may be through the vertical wall, as shown in FIGS. 6 and 8, or part of the top in the event the container has a round screw on a lid that attaches to a spout in the top. Alternatively, the tube 38 may penetrate the cover 32 directly from the top, as illustrated in FIGS. 1-3 and 12-14. In this configuration the bladder 36 is held in place underneath and becomes an integral part of the cover 32.

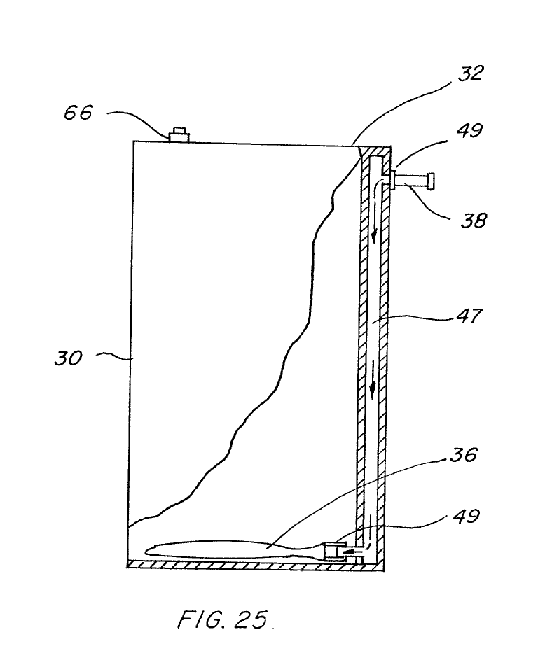

Penetration through the container 30 may be accomplished in a number of ways, such as the parent material of the container wall or covers upper surface may be pierced or formed to provide a round opening with a shank, as depicted in FIGS. 12-14. This method provides a smooth transition and eliminates a sharp edge; further, it provides a surface that allows the tube 38 to be attached with a pressure sensitive adhesive surrounding the tube that may be secured when pressure expands the tube 38 at the interface. Another method of penetration is shown in FIGS. 6, 8 and 9, wherein a barbed bulkhead connector 40 is utilized that penetrates a hole 42 in the container 30 and the tube 38 is in sections connected at both ends. When this method is used, it is preferred that the bladder 36 has an integral tube 38 for direct coupling and the remainder of the tube 38 is on the outside. To be more specific, the barbed tube bulkhead connector 40 has a first end 44 and a second end 46 with the first end 44 attached to the bladder 36 by expanding the bladder or integral tube 38 over the connector's first end 44 and attaching the tube 38 by expanding it over the second end 46 of the connector 40. Another method of penetration through the container 30 is illustrated in FIG. 25 wherein the storage container has a vertical bore 47 within its side wall for connection of the bladder within the container to the tube 38 on the containers outside surface. As illustrated, the bore 47 continues from the top to the bottom and permits attachment of the tube 38 by the use of adapters 49 that may be threaded or bonded to the side wall or even molded integrally therewith.

A valve 48 is connected to the tube's 38 distal end 50, opposite the tube's bladder connection 52. The valve's 48 function is to permit pressure to be introduced into the bladder 36 and to retain the pressure until manually released. The valve 48 may be selected from a group such as a one way valve, a check valve, a stopper, a schrader valve, a quick release valve or a pinch off valve, which are all well known in the art. The preferred valve 48 is a spring-loaded ball check type with a manual release, as illustrated in FIG. 10 in cross-section, however any other design is equally acceptable as long as it functions to allow pressure to flow into the bladder 36 but not be released until purposely relieved by manual manipulation of a feature of the valve. It should be noted that the valve 48 may also be inserted directly into the bladder 36, as shown in FIGS. 14 and 15, since the bladder 36 may contain an integral neck, as illustrated, which functions and becomes the tube 38.

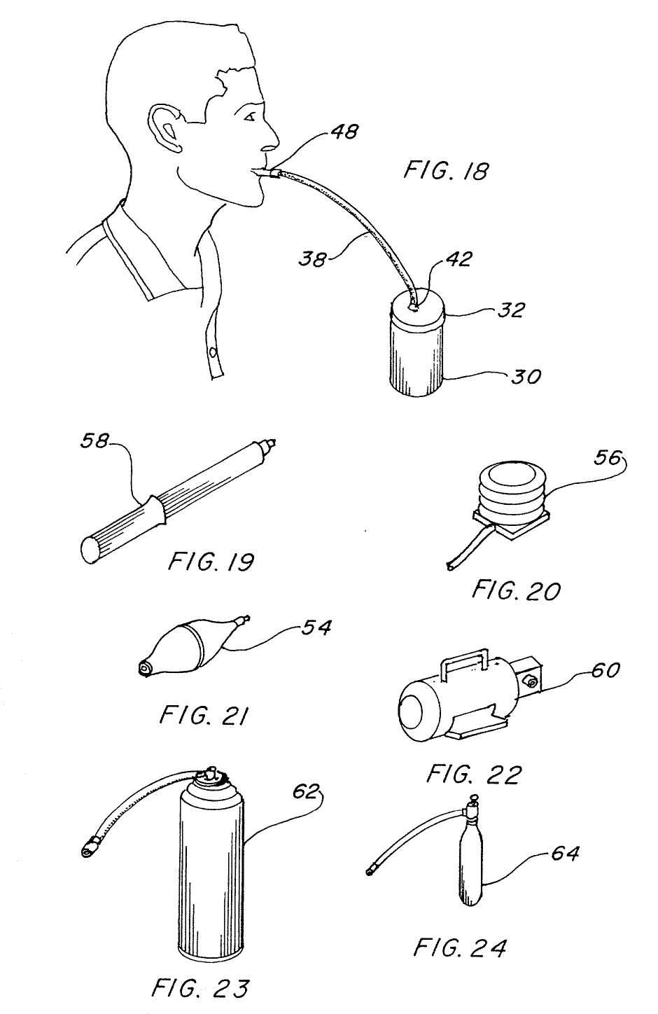

A pressure source is connectable to the valve 48 for supplying sufficient pressure to inflate the bladder 36, which then occupies any space between the product 34 within the storage container 30 and the cover 32 thus precluding ambient atmospheric contact with the product. The pressure source may be a squeeze bulb, a foot bellows pump, a hand pump, or an electric pump all well known in the art. A typical squeeze bulb 54 is shown in FIG. 21, a foot bellows pump 56 is illustrated in FIG. 20, a hand pump 58 is depicted in FIG. 19, and an electric pump 60 is shown in FIG. 22. While a sample of pumps have been illustrated, others may also be used with equal ease and dispatch.

Probably the simplest pressure source is oral pressure developed by placing the tube in one's mouth and blowing into the tube, as represented in FIG. 18. Another pressure source that would function equally well is compressed gas, which includes air and carbon dioxide that could be furnished in pressurized containers, such as a pressure can 62 shown in FIG. 23, or a carbon dioxide cartridge 64 illustrated in FIG. 24, again pressure may be easily applied by other sources available through this countries industry.

In order to complete the invention, a manually releasable pressure valve 66 is provided to discharge pressure created within the container 30 when the bladder 36 is inflated. FIGS. 11-13 depict such a valve by itself and installed through the cover 32 in a typical form, as any type or style of manual release valve could be used. In the invention's simplest operation, the manually releasable pressure valve 60 could be replaced by simply lifting or cracking one side of the cover 32 in the snap-on lid type, or partially unscrewing the cap in the threaded cover style, which accomplishes the same result. In applications where convenience is paramount, the use of some type of pressure valve 66 is mandatory. It is apparent that the invention includes a process to eliminate atmospheric air from contacting a product within a sealed storage container for prolong the products usable life which comprises the steps of forming a hole 42 in the container 30, attaching a tube 38 to an inflatable bladder 36, placing the bladder within the container interior, inserting the tube through the hole in the container, attaching a valve 48 to the tube's distal end opposite the tube's bladder attachment, and applying pressure from a pressure source connectable to the valve with sufficient pressure to inflate the bladder. This process then allows the bladder, when expanded, to occupy any space between the product and the storage container, thereby precluding ambient atmospheric contact with the product.

While the invention has been described in complete detail and pictorially shown in the accompanying drawings, it is not to be limited to such details, since many changes and modifications may be made to the invention without departing from the spirit and scope thereof. Hence, it is described to cover any and all modifications and forms which may come within the language and scope of the appended claims.

1. A container for product storage including an expandable portion to eliminate atmospheric air from contacting the product to prolong the products usable life, comprising:
a) a storage container having a cover, and product included within its interior,
b) an inflatable bladder disposed within the storage container,
c) a tube penetrating through the storage container and connected to the inflatable bladder,
d) a valve connected to the tube's distal end, opposite the tube's bladder connection, and
e) a pressure source connectable to the valve for supplying sufficient pressure to inflate the bladder, thereby occupying any space between a product within the storage container and the cover precluding ambient atmospheric contact with the product.

2. The container having an expandable portion as recited in claim 1 wherein said storage container is constructed of a material selected from a group consisting of metal, plastic, glass, cardboard and ceramic.

3. The container having an expandable portion as recited in claim 1 wherein said storage container cover is threaded to screw onto the container for air-tight sealing.

4. The container having an expandable portion as recited in claim 1 wherein said storage container cover is the snap-on type.

5. The container having an expandable portion as recited in claim 1 wherein said storage container further having a vertical bore within a side wall for connection of the bladder within the container to said tube on the containers outside surface.

6. The container having an expandable portion as recited in claim 1 wherein said inflatable bladder is constructed of a material selected from a group consisting of natural rubber, synthetic rubber, stretchable fabric impregnated with elastic sealer, and resilient thermoplastic.

7. The container having an expandable portion as recited in claim 1 further comprising a separator disposed between the product and said bladder for severing communication therebetween assuring cleanliness of the product.

8. The container having an expandable portion as recited in claim 6 wherein said separator is replaceable.

9. The container having an expandable portion as recited in claim 1 further comprising a barbed tube bulkhead connector having a first end and a second end, with the first end attached to the bladder by expanding the bladder over the connector's first end and attaching the tube by expanding the tube over the second end of the connector.

10. The container having an expandable portion as recited in claim 1 wherein said tube is integrally formed with the inflatable bladder.

11. The container having an expandable portion as recited in claim 1 wherein said tube penetrates through an outside surface of the storage container.

12. The container having an expandable portion as recited in claim 1 wherein said valve is selected from a group consisting of, a one way valve, a check valve, a stopper, a schrader valve, a quick release valve and a pinch off valve.

13. The container having an expandable portion as recited in claim 1 wherein said valve further comprises a spring-loaded ball check type with manual release.

14. The container having an expandable portion as recited in claim 1 wherein said pressure source is selected from a group consisting of a squeeze bulb, a foot bellows pump, a hand pump, or an electric pump.

15. The container having an expandable portion as recited in claim 1 wherein said pressure source further comprises an oral pressure developed by placing the tube in one's mouth and blowing into the tube.

16. The container having an expandable portion as recited in claim 1 wherein said pressure source further comprises compressed gas, including air and carbon dioxide.

17. The container having an expandable portion as recited in claim 1 wherein said storage container cover further comprises a manually-releasable pressure valve to discharge pressure created within the container when the bladder is inflated.

18. A container for product storage including an expandable portion to eliminate atmospheric air from contacting the product to prolong the products usable life, comprising:
a covered storage container having a hole therein and product included within its interior,
an inflatable bladder having an integral neck disposed within the storage container, and the neck penetrating the storage container hole and sealed thereupon,
a valve connected to the inflatable bladder neck, and
a pressure source connectable to the valve for supplying pressure sufficient to inflate the bladder therefore occupying any space between the product and the covered storage container interior, precluding ambient atmospheric contact with the product.

19. The process to eliminate atmospheric air from contacting a product within a sealed storage container to prolong the products usable life, comprising the steps of:
a) forming a hole in said container,
b) attaching a tube to an inflatable bladder,
c) placing the inflatable bladder within the container interior,
d) inserting the tube through the hole in the container
e) attaching a valve to the tubes distal end, opposite the tubes bladder attachment, and
e) applying pressure from a pressure source connectable to the valve with sufficient pressure to inflate the bladder, therefore when expanded, the bladder occupies any space between a product and the storage container precluding ambient atmospheric contact with the product.
